(19) United States
(12) Patent Application Publication
(10) Pub. No.: US 2026/0065879 A1
(43) Pub. Date: Mar. 5, 2026

(54) Dual Pick Plectrum for Strumming a Stringed Instrument

(71) Applicant: Michael Grande, Marlboro, NJ (US)

(72) Inventor: Michael Grande, Marlboro, NJ (US)

(21) Appl. No.: 18/823,742

(22) Filed: Sep. 4, 2024

(51) Int. Cl. G10D 3/173

(52) U.S. Cl. CPC G10D 3/173

(57) ABSTRACT

A dual pick plectrum for strumming a stringed instrument comprises a first pick having a first gauge and a first inner face, and a second pick having a second gauge different from the first gauge and a second inner face. An adhesive pad is positioned between and attached to the first and second inner faces, separating the picks by approximately 1 mm to 3 mm. The picks are 0.4 mm to 1.2 mm thick and approximately triangular in shape. The adhesive pad, constructed from materials such as foam, cork, wood, plastic, or metal, is positioned opposite a point of the triangular picks. The dual pick plectrum enables the creation of a greater variety of tonal qualities when strumming compared to traditional single pick designs.

### BACKGROUND

The present invention relates to the field of musical instrument accessories, and more specifically to plectrums used for strumming stringed instruments such as guitars, mandolins, ukuleles and basses.

Plectrums, also known as picks, are well known devices used for strumming or plucking the strings of various stringed instruments. Traditional plectrum designs typically consist of a single piece of rigid material, such as plastic, in a variety of shapes and thicknesses to produce different tones.

Adaptations of the traditional single plectrum design to include two connected picks for striking a string instrument have been described in the prior art. For example, U.S. Pat. No. 9,972,290 discloses a one-piece, hand-held device that enables users to pick, pluck or strum one or more strings simultaneously using a first planar plectrum parallel or nearly parallel to a second planar plectrum secured by a bracket. This provides the added functionality of a secondary striking surface for striking one string twice.

U.S. Pat. No. 8,872,008 describes a dual plectrum composite coupler comprising a spacer material with an embedded pivot core. The spacer material has inherent adhesion to hold a pair of plectrums disposed on its upper and lower surfaces. At least the tip of each plectrum does not contact the coupler.

However, prior art dual pick devices typically result in a low quality timbre and have limited versatility in creating a range of tones. The different arrangements and connection methods between the two picks in existing designs do not provide optimal configurations for producing diverse tones and strumming effects.

Therefore, there exists a need for an improved dual pick plectrum design that overcomes the limitations of the prior art and enables the creation of a greater variety of tonal qualities when strumming a stringed instrument. Such a design would expand the expressive potential for musicians over traditional single pick designs and existing dual pick arrangements.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

The present invention is directed to a dual pick plectrum for strumming a stringed instrument. The plectrum comprises a first pick having a first gauge and a first inner face, a second pick having a second gauge different from the first gauge and a second inner face, and an adhesive pad positioned between and attached to the first inner face of the first pick and the second inner face of the second pick. The adhesive pad separates the first pick and the second pick by a distance of approximately 1 mm to 3 mm.

In various embodiments, the first pick and the second pick are each 0.4 mm to 1.2 mm thick and approximately triangular in shape. The adhesive pad may be constructed from materials such as foam, cork, wood, plastic, or metal, and is positioned opposite one of the points of the triangular shape of the first pick and the second pick. The first pick and the second pick can be constructed from materials such as celluloid or ABS plastic.

The dual pick plectrum of the present invention enables the creation of a greater variety of tonal qualities when strumming a stringed instrument compared to traditional single pick designs. The different gauges of the first pick and the second pick allow the plectrum to simulate the sound of a 12-string guitar when strumming a 6-string guitar. Strumming with the first pick element contacting the strings before the second pick element produces a different tone compared to strumming with the second pick element contacting the strings before the first pick element.

These and other features and advantages of the present invention will be apparent to those skilled in the art from the following detailed description, taken together with the accompanying drawings, in which like reference numerals refer to like parts.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a perspective view of a plectrum with two picks joined by a foam pad adhesive according to the present invention.

FIG. 2 is another perspective view of the preferred embodiment of the present invention.

FIG. 3 is perspective view of the guitar being strum with the present invention, heavy gauge first.

FIG. 4 is perspective view of the guitar being strum with the present invention, light gauge first.

FIG. 5 is a profile view of the present invention showing the 2 mm-3 mm foam adhesive.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

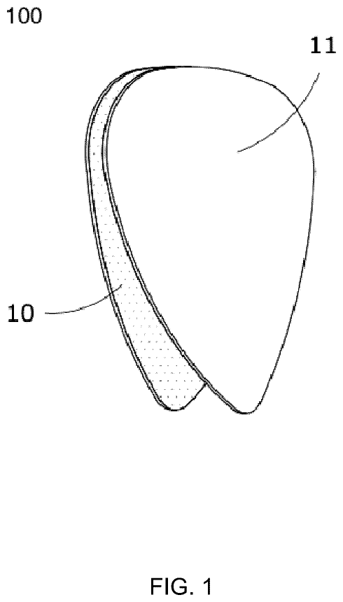

FIG. 1 is a perspective view of a dual-gauge plectrum 100 according to the present invention. The plectrum 100 comprises a first pick 10 and a second pick 11 separated by an adhesive pad 12. The first pick 10 has a first gauge, i.e., a first thickness, and a first inner face 12. The second pick 11 has a second gauge, i.e., a second thickness, different from the first gauge and a second inner face 13. The adhesive pad 12 is positioned between and attached to the first inner face 12 of the first pick 10 and the second inner face 13 of the second pick 11. The adhesive pad 12 separates the first pick 10 and the second pick 11 by a distance D of approximately 1 mm to 3 mm.

In a preferred embodiment, the first pick 10 and the second pick 11 are each constructed from a rigid, resilient material suitable for use as a plectrum, such as celluloid or ABS plastic. The first pick 10 and the second pick 11 each have a thickness between 0.4 mm and 1.2 mm. However, it should be noted that the pick gauges and thicknesses can vary beyond this range.

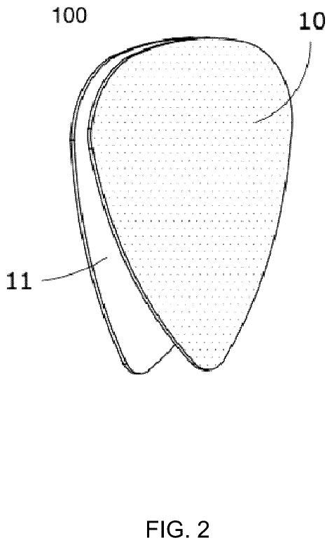

FIG. 2 is another perspective view of the dual-gauge plectrum 100 of FIG. 1, showing the opposite side of the first pick 10 and the second pick 11. In the illustrated embodiment, the first pick 10 and the second pick 11 are each approximately triangular in shape, having a generally triangular peripheral edge with three points. The adhesive pad 12 is positioned opposite one of the points of the triangular shape of both the first pick 10 and the second pick 11.

The adhesive pad 12 can be constructed from a variety of materials, such as foam, cork, wood, plastic, or metal. In a preferred embodiment, the adhesive pad 12 is constructed from a compressible foam material, such as closed cell foam, which allows the first pick 10 and the second pick 11 to flex relative to each other. The foam adhesive pad 12 is attached to the inner faces 12, 13 of the first pick 10 and second pick 11 using a suitable adhesive.

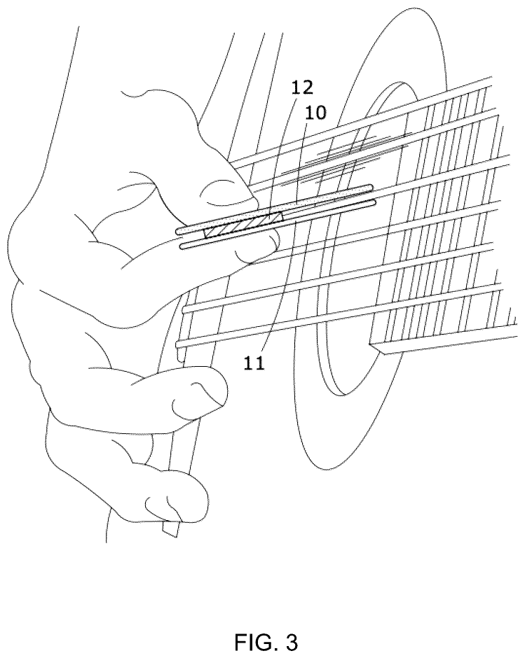

FIG. 3 is a perspective view of the dual-gauge plectrum 100 being used to strum a guitar, with the heavier gauge first pick 10 striking the strings first. The different gauges of the first pick 10 and the second pick 11 enable the plectrum 100 to simulate the sound of a 12-string guitar when strumming a 6-string guitar. When strumming with the heavier gauge first pick 10 striking the strings first, followed by the lighter gauge second pick 11, a unique tonal effect is produced.

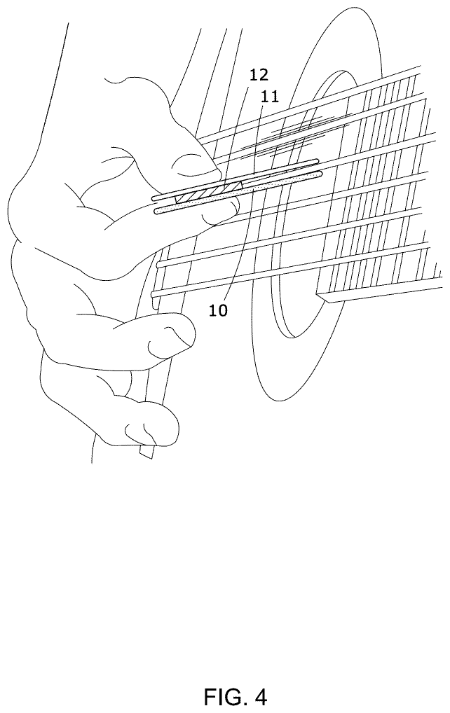

FIG. 4 is a perspective view of the dual-gauge plectrum 100 being used to strum a guitar, with the lighter gauge second pick 11 striking the strings first. When strumming with the lighter gauge second pick 11 striking the strings first, followed by the heavier gauge first pick 10, a different tonal effect is produced compared to strumming with the first pick 10 striking the strings first. The direction of the strumming motion determines which pick strikes the strings first and which pick strikes the strings second, allowing the musician to vary the tonal effect.

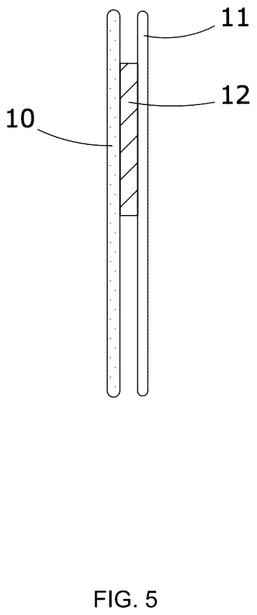

FIG. 5 is a profile view of the dual-gauge plectrum 100, showing the adhesive pad 12 separating the first pick 10 and the second pick 11. In the illustrated embodiment, the adhesive pad 12 has a thickness of approximately 1 mm to 3 mm, which has been found to provide an optimal spacing between the first pick 10 and the second pick 11 for simulating the sound of a 12-string guitar using a 6-string guitar. The adhesive pad 12 maintains the first pick 10 and second pick 11 in a spaced apart configuration while allowing them to flex relative to each other during strumming.

In the illustrated embodiment, the first pick 10 has a first color and the second pick 11 has a second color different from the first color. This allows the musician to easily distinguish between the heavier gauge pick and the lighter gauge pick. The first pick 10 and the second pick 11 each have a maximum width between 20 mm and 35 mm, which provides a comfortable size for gripping and strumming.

In use, the dual-gauge plectrum 100 is gripped by the musician, with one pick (e.g., the heavier gauge first pick 10) positioned to strike the strings first during a strumming motion. The adhesive pad 12 maintains the picks 10, 11 in a spaced apart configuration while allowing them to flex and conform to the strings during strumming. The different gauge picks 10, 11 contact the strings sequentially, producing a unique tonal effect that simulates the sound of a 12-string guitar. By varying the direction of the strumming motion, the musician can select which pick strikes the strings first and which pick strikes the strings second, producing different tonal effects.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A plectrum for strumming a stringed instrument, comprising:
a first pick having a first gauge and a first inner face;
a second pick having a second gauge different from the first gauge and a second inner face; and
an adhesive pad positioned between and attached to the first inner face of the first pick and the second inner face of the second pick,
wherein the adhesive pad separates the first pick and the second pick by a distance of approximately 1 mm to 3 mm.

2. The plectrum of claim 1, wherein the first pick and the second pick are each 0.4 mm to 1.2 mm thick.

3. The plectrum of claim 1, wherein the adhesive pad is constructed from a material selected from the group consisting of foam, cork, wood, plastic, and metal.

4. The plectrum of claim 4, wherein the adhesive pad is constructed from foam.

5. The plectrum of claim 1, wherein the first pick and the second pick are each approximately triangular in shape.

6. The plectrum of claim 6, wherein the adhesive pad is positioned opposite one of the points of the triangular shape of the first pick and the second pick.

7. The plectrum of claim 1, wherein the first pick and the second pick are each constructed from a material selected from the group consisting of celluloid and ABS plastic.

8. The plectrum of claim 1, wherein the different gauges of the first pick and the second pick enable the plectrum to simulate the sound of a 12-string guitar when strumming a 6-string guitar.

9. A dual-gauge plectrum, comprising:
a triangular first pick element having a first thickness between 0.4 mm and 1.2 mm;
a triangular second pick element having a second thickness between approximately 0.4 mm and 1.2 mm, wherein the second thickness is different from the first thickness; and
a foam adhesive pad having a thickness between approximately 1 mm and 3 mm, the foam adhesive pad attached to an inner face of the first pick element opposite one point of the triangular first pick element and to an inner face of the second pick element opposite one point of the triangular second pick element,
wherein the foam adhesive pad maintains the first pick element and second pick element in a spaced apart configuration.

10. The dual-gauge plectrum of claim 9, wherein the first thickness is greater than the second thickness.

11. The dual-gauge plectrum of claim 9, wherein the first pick element and the second pick element are constructed from celluloid or ABS plastic.

12. The dual-gauge plectrum of claim 9, wherein the foam adhesive pad is constructed from closed cell foam.

13. The dual-gauge plectrum of claim 9, wherein the foam adhesive pad maintains the first pick element and second pick element approximately 2 mm to 3 mm apart.

14. The dual-gauge plectrum of claim 9, wherein the foam adhesive pad is attached to the inner faces of the first pick element and second pick element using an adhesive.

15. The dual-gauge plectrum of claim 9, wherein the first pick element has a first color and the second pick element has a second color different from the first color.

16. The dual-gauge plectrum of claim 9, wherein the foam adhesive pad is compressible, allowing the first pick element and the second pick element to flex relative to each other.

17. The dual-gauge plectrum of claim 9, wherein the first pick element and the second pick element each have a maximum width between 20 mm and 35 mm.

18. The dual-gauge plectrum of claim 9, wherein strumming a stringed instrument with the first pick element contacting the strings before the second pick element produces a different tone compared to strumming with the second pick element contacting the strings before the first pick element.
